(19) United States
(12) Patent Application Publication
(10) Pub. No.: US 2017/0361588 A1
(43) Pub. Date: Dec. 21, 2017

(54) FIBER STRUCTURE HAVING HALOGEN-FREE FOAMING POLYMER LAYER

(71) Applicant: Hyundai Motor Company, Seoul (KR)

(72) Inventors: Oh-Deok Kwon, Suwon (KR); Hyun-Dae Cho, Seongnam (KR); Hong-Chan Jeon, Suwon (KR); Myung-Ryoul Lee, Seoul (KR); Bong-Hyun Park, Gunpo (KR); Keun-Soo Moon, Hwaseong (KR); Hyun-Sik Hwang, Pyeongtaek (KR); Joo-Suk Chae, Daejeon (KR); Won-Kyu Park, Hwaseong (KR)

(21) Appl. No.: 15/266,082

(22) Filed: Sep. 15, 2016

(30) Foreign Application Priority Data
Jun. 15, 2016 (KR) 10-2016-0074292

(51) Int. Cl. B32B 27/12; B32B 5/20; B32B 27/30; C08J 9/10; B32B 5/02; C08J 9/00; B32B 7/12

(52) U.S. Cl. CPC B32B 27/12; C08J 9/0061; B32B 5/20; B32B 7/12; C08J 9/106; C08J 9/10; B32B 5/02; B32B 27/302; B32B 2605/003; C08J 2325/10; C08J 2423/12

(57) ABSTRACT

Disclosed is a fiber structure including a halogen-free polymer layer such as a styrenic block (SBC) copolymer. The fiber structure has environmentally-friendly properties and reduced weight, as compared to conventional materials such as PVC and has improved low temperature stability, fixing ability and resistance to deformation.

### CROSS-REFERENCE TO RELATED APPLICATION

This application claims the priority benefit of Korean Patent Application No. 10-2016-0074292, filed on Jun. 15, 2016 in the Korean Intellectual Property Office, the disclosure of which is incorporated herein by reference.

### TECHNICAL FIELD

The present invention relates to a fiber structure having a halogen-free polymer layer that may include a styrenic block copolymer (SBC).

### BACKGROUND OF THE INVENTION

Fibers form fiber structures as used in various mats, polyester fibers, nylon fibers and mixed fibers thereof, and polymeric materials have been used as backing layer/back coating layers thereof. Particularly, when those materials are used in a vehicle mat application produce, weight reduction as well as environmental problems thereof has been focused, and thus, various types of lightweight products have been developed.

The polymeric material used as a backing layer of a foaming mat can have waterproof function of a fiber product and maintain the shape of the fiber product and thus requires properties, such as softness, rapid restoration with respect to deformation, heat resistance and slip resistance.

Among polymeric materials which satisfy these property requirements and are used as backing layers of various fiber laminates and coated fibers, soft polyvinyl chloride (PVC) has excellent processability and price competitiveness and has been thus most widely used.

However, the PVC material including a plasticizer emits substances harmful to humans, such as hydrogen chloride gas, dioxin, and the like, upon combustion. In addition, the PVC material includes various heavy metals as additives, and thus becomes a target of environmental regulation. Further, the PVC material has a high specific gravity and thus cannot satisfy a lightweight trend.

Accordingly, non-woven fabric products having improved weight and compound products using non-foaming styrene butadiene styrene thermosetting rubber have been used as substitutes. Further, compound products of polyethylene, polypropylene, ethylene-vinyl acetate, and the like based on olefin are mentioned, but balance between processability and properties thereof may not be secured and thus use thereof may be limited.

Accordingly, development of technology regarding a fiber structure, which minimizes the above described problems, is environmentally friendly, reduces specific gravity, as compared to conventional fiber structures, and is soft to the touch so as to have improved commercial quality, has been required.

The foregoing is intended merely to aid in the understanding of the background of the present invention, and is not intended to mean that the present invention falls within the purview of the related art that is already known to those skilled in the art.

### SUMMARY OF THE INVENTION

In preferred aspects, the present invention provides a fiber structure which may prevent environmental problems from conventional use of PVC and may have improved low temperature stability and resistance to deformation.

Further, the present invention provides a fiber structure which may use a foaming material, which is different from conventional materials, such as PVC, and the like, and may thus reduce weight and cost.

However, technical objects to be achieved by the present invention are not limited to those mentioned above, and other objects may be clearly understood by those skilled in the art from the description given below.

In one aspect, the present invention may provide a fiber structure including a fiber layer, an adhesive layer and a polymer layer.

In one preferred aspect, the polymer layer may be a foaming polymer layer.

The polymer layer may include a styrenic block copolymer (SBC), a halogen-free polymer and an inorganic foaming agent.

The polymer layer may further include an oil component and a filler.

The “oil component” as used herein refers to a component that may promote a process of during forming the polymer layer. Exemplary oil component may include a saturated fat such as paraffin or paraffin-based oil. The “filler” as used herein refers to a material added to a polymer mixture to improve properties or be used as a binding material between the mixture components. Exemplary filler may include both inorganic and organic materials such as calcium carbonate, talc, silica (silicon oxide) and combinations thereof.

The styrenic block copolymer (SBC) may include one or more selected from the group consisting of styrene butadiene styrene (SBS), styrene isoprene styrene (SIS), styrene ethylene butylene styrene (SEBS), styrene ethylene propylene styrene (SEPS), and styrene ethylene ethylene propylene styrene (SEEPS).

The styrene butadiene styrene (SBS) may be present in an amount of 0 to about 30% by weight with respect to the total weight of the fiber structure.

The styrene isoprene styrene (SIS) may be present in an amount of 0 to about 10% by weight with respect to the total weight of the fiber structure.

The styrene ethylene butylene styrene (SEBS) may be present in an amount of about 20 to 50% by weight with respect to the total weight of the fiber structure.

The halogen-free polymer may be an olefin-based polymer or a styrene-based polymer.

The olefin-based polymer may include one or more selected from the group consisting of high density polyethylene (HDPE), low density polyethylene (LDPE), linear low density polyethylene (LLDPE), polypropylene (PP) and ethylene vinyl acetate (EVA).

The olefin-based polymer may be present in an amount of about 10 to 30% by weight with respect to the total weight of the fiber structure.

The styrene-based polymer may include one or more selected from the group consisting of general purpose polystyrene (GPPS), high impact polystyrene (HIPS) and styrene maleic anhydride (SMA).

The styrene-based polymer may be present in an amount of 0 to about 10% by weight with respect to the total weight of the fiber structure.

The inorganic foaming agent may include one or more selected from the group consisting of sodium bicarbonate (NaHCO₃), ammonium carbonate ((NH₄)₂CO₃), ammonium bicarbonate (NH₄HCO₃), ammonium nitride (NH₄NO₂), azides and a metal compound.

The metals may include magnesium (Mg), zinc (Zn) and aluminum (Al).

The inorganic foaming agent may be present in an amount of about 2 to 10% by weight with respect to the total weigh of the fiber structure.

The fiber layer, the adhesive layer and the polymer layer may be sequentially formed.

Further provided is a vehicle mat that may comprise the fiber structure as described herein.

Other aspects of the invention are disclosed infra.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exemplary fiber structure according to an exemplary embodiment of the present invention.

### DETAILED DESCRIPTION OF THE PREFERRED EMBODIMENTS

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, the present invention will be described in detail with reference to the accompanying drawings to allow those skilled in the art to easily practice the present invention. The terms or words used in the specification and claims of the present invention are not interpreted to have typical or dictionary limited meanings, and are interpreted to have meanings and concepts conforming to the technical sprit of the present invention based on the principle that the inventors can appropriately define the concepts of the terms to explain the present invention in the best manner. Accordingly, it is to be understood that the detailed description, which will be disclosed along with the accompanying drawings, is intended to describe the exemplary embodiments of the present invention and is not intended to represent all technical ideas of the present invention. Therefore, it should be understood that various equivalents and modifications can exist which can replace the embodiments described at the time of application.

In one aspect, a fiber structure may include a fiber layer, an adhesive layer and a polymer layer. The polymer layer may include a styrenic block copolymer (SBC), a halogen-free polymer and an inorganic foaming agent.

In preferred aspects, the polymer layer may be a foaming layer. Preferred foaming layer will contain foam including gas in a liquid resin or solid (cured) resin. The foaming layer may not be particularly limited by volumes or internal volumes.

In the present invention, in order to solve various problems generated from a composite material of a halogen-free fiber backing layer and problems of a product using a foaming agent, such as poor heat resistance and slip resistance, a styrene butadiene styrene (SBS)-based material may be suitably used. Further, a foaming agent for the SBS-based material may be selected and a fiber backing layer may be manufactured by securing processing conditions through many extrusion tests using a compound as a result product and by changing machinery, such as change of an extruder die.

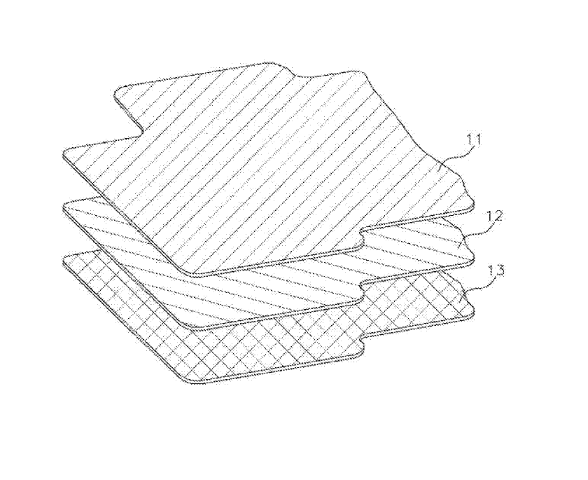

Now, the present invention will be described in more detail. As shown in FIG. 1, the fiber structure in accordance with the present invention may include a fiber layer 11, an adhesive layer 12 and a polymer layer 13, and polyester fibers, nylon fibers and mixed fibers thereof are used as fibers used in the fiber layer 11.

Preferably, the polymer layer 13 of the fiber structure may include a styrenic block copolymer (SBC), which is a thermoplastic elastomer, a halogen-free material, a foaming agent, other additives, and the like and mixing thereof may be carried out using a super mixer or a ribbon mixer. Further, pellets may be manufactured through water cooling using a twin-screw extruder set to have a temperature of about 160 to 200° C., a screw speed of about 240 to 300 rpm, and a feeding speed of about 600 to 800 rpm into a hopper, a test specimen for measuring properties may be manufactured by an injection molding machine using the pellets, and mechanical properties of the test specimen may be measured, which is described later.

In the present invention, the polymer layer 13 may be formed of a halogen-free material based on a styrenic block copolymer (SBC), which may be environmentally friendly and may have reduced weight as compared to a PVC material. The polymer layer 13 may be formed of a compound including an amount of about 20 to 60% by weight of an SBC-based polymer, an amount of about 10 to 30% by weight of a halogen-free polymer, an amount of 0 to about 10% by weight of a styrene-based polymer, an amount of about 10 to 40% by weight of an oil component, an amount of about 5 to 30% by weight of a filler, an amount of about 2 to 10% by weight of an inorganic foaming agent, and other additives. All the % by weight are based on the total weight of the polymer.

The polymer layer 13 may further include an oil component and a filler. Further, the SBC compound may include various additives, such as a process oil (secondary oil component), an antioxidant, an antistatic agent, a flame retardant, and the like, if necessary.

The styrenic block copolymer (SBC) may include one or more selected from the group consisting of styrene butadiene styrene (SBS), styrene isoprene styrene (SIS), styrene ethylene butylene styrene (SEBS), styrene ethylene propylene styrene (SEPS), and styrene ethylene ethylene propylene styrene (SEEPS).

Further, styrene butadiene styrene (SBS) may be present in an amount of 0 to about 30% by weight with respect to the total weight of the fiber structure, styrene isoprene styrene (SIS) may be present in an amount of 0 to about 10% by weight with respect to the total weight of the fiber structure, and styrene ethylene butylene styrene (SEBS) may be present in an amount of 20 to 50% by weight with respect to the total weight of the fiber structure.

The halogen-free polymer may be an olefin-based polymer or a styrene-based polymer. Preferably, the halogen-free polymer included in the compound may be an olefin-based polymer or a styrene-based polymer, and the halogen-free polymer and the SBC-based polymer may be independently used to be compounded or two or more kinds of polymers (an olefin-based polymer and a styrene-based polymer) may be used together to be compounded.

The olefin-based polymer may include one or more selected from the group consisting of high density polyethylene (HDPE), low density polyethylene (LDPE), linear low density polyethylene (LLDPE), polypropylene (PP) and ethylene vinyl acetate (EVA), however, particular kinds thereof may not be limited thereto. The olefin-based polymer suitably may use one or more kinds thereof. For example, when the SBC-based polymer and only the olefin-based polymer are used to be compounded, the olefin-based polymer may be present in an amount of about 10 to 30% by weight with respect to the weight of the compound.

Further, the olefin-based polymer may be present in an amount of about 10 to 30% by weight with respect to the total weight of the fiber compound.

Alternatively, instead of the olefin-based polymer, the styrene-based polymer may be solely used.

The styrene-based polymer may include one or more selected from the group consisting of general purpose polystyrene (GPPS), high impact polystyrene (HIPS) and styrene maleic anhydride (SMA), however, particular kinds thereof may not be limited.

The styrene-based polymer may be present in an amount of 0 to about 10% by weight with respect to the total weight of the fiber structure.

In the fiber structure of the present invention, the foaming agent causes weight reduction, less deformation, cost and material reduction, and the like, and an organic or inorganic foaming agent may be used as the foaming agent. An inorganic foaming agent used in the present invention may include one or more selected from the group consisting of sodium bicarbonate (NaHCO₃), ammonium carbonate ((NH₄)₂CO₃), ammonium bicarbonate (NH₄HCO₃), ammonium nitride (NH₄NO₂), azides and a metal component.

Further, the light metals may include magnesium (Mg), zinc (Zn) and aluminum (Al), and the inorganic foaming agent may be present in an amount of about 2 to 10% by weight with respect to the total weight of the fiber structure.

The fiber layer 11, the adhesive layer 12 and the polymer layer 13 may be sequentially formed.

A single-screw or twin-screw extruder may be used as an extruder necessary to manufacture the fiber structure of the present invention. For example, a single-screw extruder may be used in a pre-test for evaluating the fiber structure of the present invention, and a new T-die mold for molding a sheet may be manufactured and used to execute a property evaluation test which will be described later.

The most important factors influencing nucleation of a foaming sheet product may be temperature and pressure. As a temperature increases and a pressure decreases, foaming may be facilitated. Therefore, as factors on which relations between temperature and pressure have a strong influence during processing, sheet processing may be carried out at an extruder barrel temperature of about 160 to 220° C. and a T-die mold temperature of about 150 to 220° C. Further, in order to execute a simple durability test of a mat, laminating with fiber may be executed to facilitate mass-production.

The following Table 1 comparatively shows specific gravities, tensile strengths (TS) and elongations (EI) of conventionally used PVC and SBS materials.

TABLE 1

| Division | Specific gravity | TS(kgf/cm²) | EI(%) |
|---|---|---|---|
| PVC | 1.4~1.7 | 20~40 | 100 or less |
| SBS | 1.0~1.2 | 30~50 | 300 or more |

The fiber structure of the present invention may have a lower specific gravity than those of materials which have been mass-produced, i.e., PVC and SBS, as indicated in Table 1 above. In addition, the mechanical properties, i.e., tensile strength, elongation, and the like may be equal to those of the conventional materials.

The following Table 2 shows compositions of polymer layers 13 of Test examples of the present invention.

TABLE 2

| | | Test example (wt %) | | | | | | | | | | | | | | |
|---|---|---|---|---|---|---|---|---|---|---|---|---|---|---|---|---|
| Composition | | #1 | #2 | #3 | #4 | #5 | #6 | #7 | #8 | #9 | #10 | #11 | #12 | #13 | #14 | #15 |
| SBC | SBS | 26 | | 5 | 13 | | 10 | 6 | | 5 | 20 | | 23 | 7 | 10 | |
| | SIS | | | | | 5 | 5 | | 8 | | | 5 | | 5 | | |
| | SEBS | | 26 | 31 | 30 | 34 | 25 | 35 | 30 | 48 | 23 | 34 | 20 | 30 | 30 | 37 |
| Olefin | LDPE | 6 | 6 | 25 | 20 | 10 | | 8 | 10 | 10 | 10 | 5 | | | 20 | 10 |
| | LLDPE | | | 5 | | | | | | 5 | | 5 | | 10 | 10 | |
| | HOMO | 10 | 5 | | | 5 | | 5 | | | | | | 10 | | |
| | CO | | | | 5 | | 10 | | | | 5 | | 8 | | | |
| | Random | | 5 | | | | | | 5 | | 5 | 8 | | | | |
| | EVA | | | | | | | | | | | | | | | |
| Styrenic | HIPS | | | | | | 5 | | | | | | 5 | | | |
| Oil | Paraffin- | 28 | 28 | 20 | 20 | 30 | 30 | 30 | 25 | 20 | 25 | 30 | 29 | 25 | 10 | 40 |
| component | based | | | | | | | | | | | | | | | |
| Fillers | Calcium | 28 | 27 | | | | 10 | 14 | | | | | 10 | 10 | | |
| | carbonate | | | | | | | | | | | | | | | |
| | Talc | | | 5 | 10 | 5 | | | 20 | 5 | 10 | 5 | | | 5 | 5 |
| | Silica | | | 5 | | 5 | | | | 4 | | 5 | | | 5 | 5 |
| Foaming | Inorganic | 2 | 3 | 4 | 2 | 6 | 5 | 2 | 2 | 3 | 2 | 3 | 5 | 3 | 10 | 3 |
| agent | foaming | | | | | | | | | | | | | | | |
| | agent | | | | | | | | | | | | | | | |
| Sum | | 100 | 100 | 100 | 100 | 100 | 100 | 100 | 100 | 100 | 100 | 100 | 100 | 100 | 100 | 100 |

Further, the following Table 3 shows measured values of mechanical properties of Test examples of the present invention.

TABLE 3

| | | Test example (Wt %) | | | | | | | |
|---|---|---|---|---|---|---|---|---|---|
| Composition | | #1 | #2 | #3 | #4 | #5 | #6 | #7 | #8 |
| Mechanical | Specific | 0.92 | 0.90 | 0.82 | 0.86 | 0.79 | 0.81 | 0.82 | 0.85 |
| properties | gravity | | | | | | | | |
| | TS | 24 | 60 | 50 | 25 | 26 | 23 | 38 | 35 |
| | (kgf/cm²) | | | | | | | | |
| | EI | 230 | 450 | 320 | 200 | 220 | 200 | 380 | 350 |
| | (%) | | | | | | | | |

| | | Test example (Wt %) | | | | | | |
|---|---|---|---|---|---|---|---|---|
| Composition | | #9 | #10 | #11 | #12 | #13 | #14 | #15 |
| Mechanical | Specific | 0.75 | 0.86 | 0.79 | 0.81 | 0.86 | 0.71 | 0.83 |
| properties | gravity | | | | | | | |
| | TS | 30 | 40 | 32 | 23 | 50 | 22 | 39 |
| | (kgf/cm²) | | | | | | | |
| | EI | 320 | 400 | 320 | 260 | 300 | 210 | 410 |
| | (%) | | | | | | | |

On the other hand, the following Table 4 shows compositions of polymer layers of Comparative examples.

TABLE 4

| | | Comparative example (wt %) | | | | |
|---|---|---|---|---|---|---|
| Composition | | #1 | #2 | #3 | #4 | #5 |
| SBC | SBS | | | | 22 | 22 |
| | SIS | | | | | |
| | SEBS | 9 | 9 | 22 | | |
| Olefin | LDPE | | | | | |
| | LLDPE | | 12 | | | |
| | HOMO | | | | | |
| | CO | | | 15 | 15 | |
| | Random | | 10 | | | |
| | EVA | 22 | | | | 15 |
| Styrenic | HIPS | | | | | |
| Process | Paraffin- | 24 | 24 | 30 | 30 | 26 |
| coil | based | | | | | |
| Filler | Calcium | 27 | 23 | 20 | 29 | 26 |
| | carbonate | | | | | |
| | Talc | | 20 | | | |
| | Silica | 15 | | 10 | | 5 |
| Foaming | Inorganic | 3 | 2 | 3 | 4 | 6 |
| agent | foaming | | | | | |
| | agent | | | | | |
| Sum | | 100 | 100 | 100 | 100 | 100 |

Further, the following Table 5 shows measured values of mechanical properties of Comparative examples.

TABLE 5

| | | Comparative example (wt %) | | | | |
|---|---|---|---|---|---|---|
| Composition | | #1 | #2 | #3 | #4 | #5 |
| Mechanical | Specific | 1.03 | 1.05 | 1.01 | 1.05 | 1.05 |
| properties | gravity | | | | | |
| | TS | 36 | 27 | 62 | 48 | 38 |
| | (kgf/cm²) | | | | | |
| | EI (%) | 480 | 360 | 590 | 420 | 360 |

As exemplarily shown in Tables 2 to 5, it may be understood that the fiber structures in accordance with Test Examples of the present invention may have specific gravities in a range of about 0.71 to 0.92, which are reduced as compared to those of Comparative examples. Further, Test Examples may have tensile strengths of about 22 to 60 kgf/cm² and elongations of about 210 to 450%, which are equal to those of Comparative examples, thereby securing sufficient mass-production ability.

Further, as results of analysis of environmentally hazardous substances from the fiber structures of Test examples, substances, such as chlorine, lead, cadmium, chrome, mercury, were not detected.

Moreover, a fiber structure in accordance with the present invention may be applied to textile products, such as bags, shoes, household mats, and the like in addition to vehicle mats.

Accordingly, the fiber structure in accordance with the present invention may provide following advantages.

The fiber structure may not contain toxic substances, such as a unreacted vinyl chloride monomer (VCM), dioctyl phthalate (DOP), and the like form the conventional use of PVC, and thus, may decrease a generation amount of harmful gas, such as dioxin, when the fiber structure is burned, and may not include heavy metals and be environmentally friendly, In addition, the fiber structure may have a reduced specific gravity than other materials, such as PVC, and thus may have reduced weight effects of about 30% or greater. Further, the fiber structure may be soft based on the nature of a material and thus may have improved low temperature stability and improved fixing ability when the fiber structure is conventionally applied in a vehicle, and may have improved resistance to deformation according to change of external environmental conditions, such as temperature and humidity. Moreover, the fiber structure may reduce cost due to use of a foaming material, as compared to PVC, when the fiber structure is used for vehicles.

Although the various exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A fiber structure comprising:
a fiber layer,
an adhesive layer and
a polymer layer,
wherein the polymer layer comprises a styrenic block copolymer (SBC), a halogen-free polymer and an inorganic foaming agent.

2. The fiber structure of claim 1, wherein the polymer layer is a foaming polymer layer.

3. The fiber structure according to claim 1, wherein the polymer layer further comprises an oil component and a filler.

4. The fiber structure according to claim 1, wherein the styrenic block copolymer (SBC) comprises one or more selected from the group consisting of styrene butadiene styrene (SBS), styrene isoprene styrene (SIS), styrene ethylene butylene styrene (SEBS), styrene ethylene propylene styrene (SEPS), and styrene ethylene ethylene propylene styrene (SEEPS).

5. The fiber structure according to claim 4, wherein the styrene butadiene styrene (SBS) is present in an amount of 0 to about 30% by weight with respect to the total weight of the fiber structure.

6. The fiber structure according to claim 4, wherein the styrene isoprene styrene (SIS) is present in an amount of 0 to about 10% by weight with respect to the total weight of the fiber structure.

7. The fiber structure according to claim 4, wherein the styrene ethylene butylene styrene (SEBS) is present in an amount of about 20 to 50% by weight with respect to the total weight of the fiber structure.

8. The fiber structure according to claim 1, wherein the halogen-free polymer is an olefin-based polymer or a styrene-based polymer.

9. The fiber structure according to claim 8, wherein the olefin-based polymer includes one or more selected from the group consisting of high density polyethylene (HDPE), low density polyethylene (LDPE), linear low density polyethylene (LLDPE), polypropylene (PP) and ethylene vinyl acetate (EVA).

10. The fiber structure according to claim 8, wherein the olefin-based polymer is present in an amount of about 10 to 30% by weight with respect to the total weight of the fiber structure.

11. The fiber structure according to claim 8, wherein the styrene-based polymer includes one or more selected from the group consisting of general purpose polystyrene (GPPS), high impact polystyrene (HIPS) and styrene maleic anhydride (SMA).

12. The fiber structure according to claim 8, wherein the styrene-based polymer is present in an amount of 0 to about 10% by weight with respect to the total weight of the fiber structure.

13. The fiber structure according to claim 1, wherein the inorganic foaming agent includes one or more selected from the group consisting of sodium bicarbonate (NaHCO₃), ammonium carbonate ((NH₄)₂CO₃), ammonium bicarbonate (NH₄HCO₃), ammonium nitride (NH₄NO₂), azides and a metal component.

14. The fiber structure according to claim 13, wherein the metal component comprises magnesium (Mg), zinc (Zn) and aluminum (Al).

15. The fiber structure according to claim 13, wherein the inorganic foaming agent is present in an amount of about 2 to 10% by weight with respect to the total weight of the fiber structure.

16. The fiber structure according to claim 1, wherein the fiber layer, the adhesive layer and the polymer layer are sequentially formed.

17. A vehicle mat comprising a fiber structure according to claim 1.
